(19) United States
(12) Patent Application Publication
(10) Pub. No.: US 2021/0331616 A1
(43) Pub. Date: Oct. 28, 2021

(54) FREIGHT TRANSPORT CARRIER

(71) Applicant: Marion Body Works, Inc., Marion, WI (US)

(72) Inventors: Vincenzo Theodore Speziale, Marion, WI (US); Lawrence James Czarnecki, Marion, WI (US); Jerry Richard Ratajczak, Marion, WI (US)

(73) Assignee: Marion Body Works, Inc., Marion, WI (US)

(21) Appl. No.: 17/240,315

(22) Filed: Apr. 26, 2021

Related U.S. Application Data
(60) Provisional application No. 63/016,765, filed on Apr. 28, 2020.

(51) Int. Cl. B60P 1/44; B62D 33/02; B60P 1/52; B65G 67/04

(52) U.S. Cl. CPC B60P 1/4421; B62D 33/02; B65G 67/04; B60P 1/52; B60P 1/4478

(57) ABSTRACT

A freight transport carrier comprises a tractor unit, a slave tray loading unit, and a slave tray actuation mechanism. The tractor unit comprises a chassis, a plurality of wheels coupled to the chassis, and a power source configured to selectively provide rotational motion to the plurality of wheels. The slave tray loading unit is coupled to the chassis of the tractor unit and comprises a plurality of slave trays. At least one of the plurality of slave trays is an actuatable slave tray that is selectively actuatable between a first or lowered position, in which the actuatable slave tray is configured to receive a load, and a second or raised position, in which the actuatable slave tray is configured to transport the load. The slave tray actuation mechanism is configured to selectively actuate the actuatable slave tray between the first or lowered position and the second or raised position.

### CROSS-REFERENCE TO RELATED APPLICATIONS

This application claims priority to U.S. Provisional Patent Application No. 63/016,765, entitled “Freight Transport Carrier,” filed on Apr. 28, 2020, which is incorporated herein by reference in its entirety.

### BACKGROUND

The present disclosure relates to freight transport carriers including, but not limited to, vehicles suited for loading aircraft. Traditionally, tug and dolly systems have been used as freight transport carriers for transporting loads (e.g., cargo, freight, baggage) between terminals and aircraft at airports. However, tug and dolly systems typically have a variety of associated downfalls. For example, the wheels of dollies are prone to failure. For this reason, the wheels of the dollies must frequently be replaced, adding costs associated with replacement tires, continued upkeep, and downtime of various dollies.

### SUMMARY

One example embodiment relates to a freight transport carrier comprising a tractor unit, a slave tray loading unit, and a slave tray actuation mechanism. The tractor unit comprises a chassis, a plurality of wheels coupled to the chassis, and a power source configured to selectively provide rotational motion to the plurality of wheels. The slave tray loading unit is coupled to the chassis of the tractor unit and comprises a plurality of slave trays. At least one of the plurality of slave trays is an actuatable slave tray that is selectively actuatable between a first or lowered position, in which the actuatable slave tray is configured to receive a load, and a second or raised position, in which the actuatable slave tray is configured to transport the load. The slave tray actuation mechanism is configured to selectively actuate the actuatable slave tray between the first or lowered position and the second or raised position.

Another example embodiment relates to a freight transport carrier comprising a tractor unit, a slave tray loading unit, a slave tray actuation mechanism, and a controller. The tractor unit comprises a chassis, a plurality of wheels rotatably coupled to the chassis, and a power source configured to selectively provide rotational motion to the plurality of wheels. The slave tray loading unit is coupled to the chassis of the tractor unit and comprises a plurality of slave trays. At least one of the plurality of slave trays is an actuatable slave tray that is selectively actuatable between a first or lowered position, in which the actuatable slave tray is configured to receive a load, and a second or raised position, in which the actuatable slave tray is configured to transport the load. The slave tray actuation mechanism is configured to selectively actuate the actuatable slave tray between the lowered position and the raised position. The controller is communicably coupled to the power source and the slave tray actuation mechanism and is configured to prevent actuation of the slave tray actuation mechanism while the freight transport carrier is in motion.

Another example embodiment relates to a freight transport carrier comprising a tractor unit, a slave tray loading unit, and a slave tray actuation mechanism. The tractor unit comprises a chassis, a plurality of wheels rotatably coupled to the chassis, and a power source configured to selectively provide rotational motion to the plurality of wheels. The slave tray loading unit is coupled to the chassis of the tractor unit and comprises a plurality of slave trays. At least one of the plurality of slave trays is an actuatable slave tray that is selectively actuatable between a first or lowered position, in which the actuatable slave tray is configured to receive a load, and a second or raised position, in which the actuatable slave tray is configured to transport the load. The slave tray actuation mechanism is configured to selectively actuate the actuatable slave tray between the lowered position and the raised position. The slave tray actuation mechanism comprises a mast assembly coupled to a rear end of the chassis, a mast support assembly coupled to the chassis and configured to support the mast assembly, an actuatable slave tray support assembly coupled to the mast assembly and configured to support the actuatable slave tray, and an actuation power source configured to selectively actuate the mast assembly between a retracted position, in which the actuatable slave tray is in the raised position, and an extended position, in which the actuatable slave tray is in the lowered position.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a left side elevation view of a freight transport carrier, shown with an actuatable rear slave tray in a raised position, according to an exemplary embodiment.

FIG. 2 is a top plan view of the freight transport carrier of FIG. 1, shown with the actuatable rear slave tray in the raised position, according to an exemplary embodiment.

FIG. 3 is a rear elevation view of the freight transport carrier of FIG. 1, shown with the actuatable rear slave tray in the raised position, according to an exemplary embodiment.

FIG. 4 is a right side perspective view of a rear portion of the freight transport carrier of FIG. 1, shown with the actuatable rear slave tray in the raised position, according to an exemplary embodiment.

FIG. 5 is a left side elevation view of the freight transport carrier of FIG. 1, shown with the actuatable rear slave tray in a lowered position, according to an exemplary embodiment.

FIG. 6 is a rear elevation view of the freight transport carrier of FIG. 1, shown with the actuatable rear slave tray in the lowered position, according to an exemplary embodiment.

FIG. 7 is a right side perspective view of a rear portion of the freight transport carrier of FIG. 1, shown with the actuatable rear slave tray in the lowered position, according to an exemplary embodiment.

FIG. 8 is a detail view of a slave tray locking mechanism of the freight transport carrier of FIG. 1, shown with the slave tray locking mechanism in an opened position, according to an exemplary embodiment.

FIG. 9 is a detail view of the slave tray locking mechanism of the freight transport carrier of FIG. 1, shown with the slave tray locking mechanism in a locked position, according to an exemplary embodiment.

FIG. 10 is another detail view of the slave tray locking mechanism of the freight transport carrier of FIG. 1, shown with the slave tray locking mechanism in the opened position, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a freight transport carrier is shown. The freight transport carrier includes a selectively-actuatable slave tray configured to move between two or more positions, for example, a first or lowered and a second or raised position. The freight transport carrier further includes at least one slave tray locking mechanism configured to lock the selectively-actuatable slave tray in the raised position. When utilized in the process of loading and unloading freight from an aircraft, the freight transport carrier may allow for reduced maintenance costs associated with replacement parts and vehicle downtime, as compared to traditional freight transport carriers (e.g., tug and dolly systems).

Additionally, the freight transport carrier includes an enclosed driver compartment. Traditionally, freight transport carriers (e.g., tug and dolly systems) have been open-air. Thus, the freight transport carrier provided herein may advantageously provide protection to the driver of the freight transport carrier. For example, the freight transport carrier may protect the driver from weather-related hazards (e.g., precipitation, extreme outdoor temperatures, lightning).

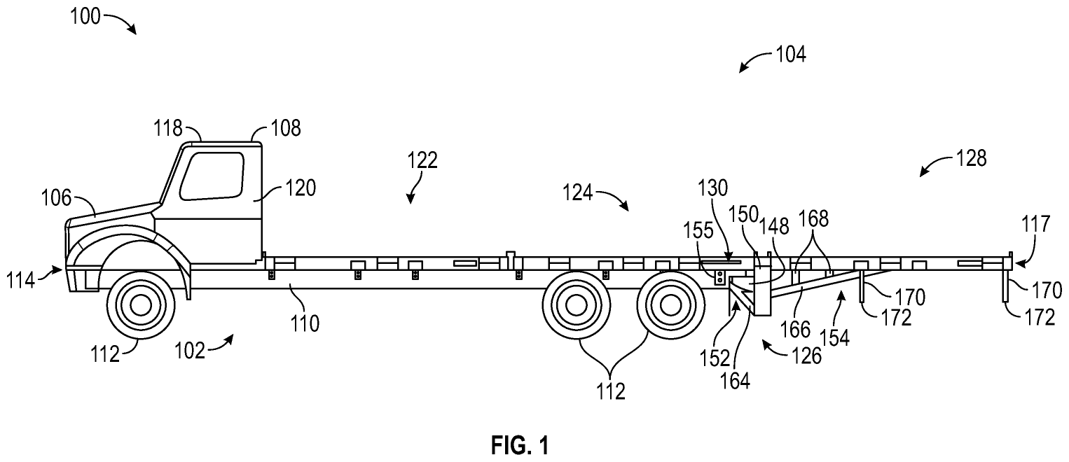

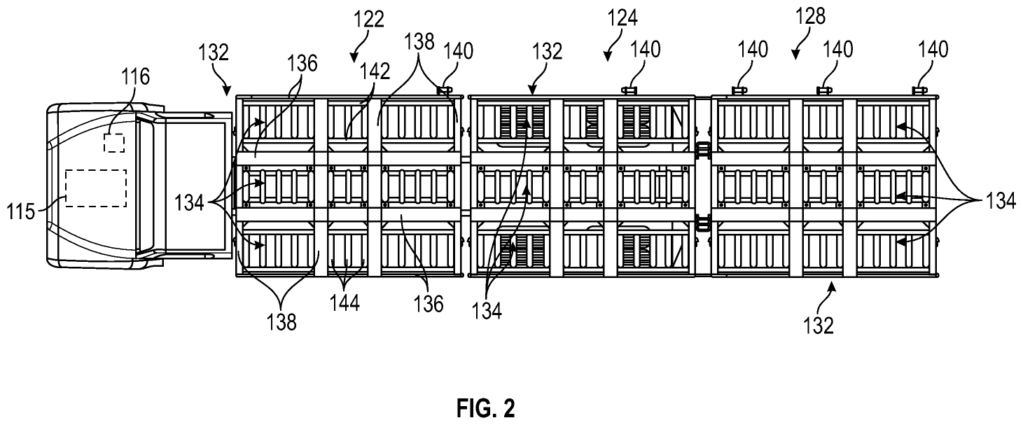

Referring now to FIG. 1, a freight transport carrier 100 is shown, according to an exemplary embodiment. The freight transport carrier 100 includes a tractor unit 102 and a slave tray loading unit 104 coupled to or mounted to the tractor unit 102. The tractor unit 102 includes a power source compartment 106, a driver's compartment 108, a chassis 110, and a plurality of wheels 112. The power source compartment 106 is disposed at or proximate to a front end 114 of the freight transport carrier 100. The power source compartment 106 may include or house a power source 115 (shown in FIG. 2) comprising an engine (e.g., a combustion engine), a motor (e.g., an electric motor), or any other suitable power source configured to provide rotational motion to the plurality of wheels 112 (e.g., through a drivetrain system). The power source 115 is in communication with a controller 116 (shown in FIG. 2). In some instances, the controller 116 may be configured to govern a top speed of the freight transport carrier 100. For example, the controller 116 may be configured to govern or limit the top speed of the freight transport carrier 100 to below a specified limit, for example, thirty miles per hour.

The driver's compartment 108 is preferably, but not necessarily, coupled to the power source compartment 106. The driver's compartment 108 is further disposed rearward of the power source compartment 106 (i.e., closer to a rear end 117 of the freight transport carrier 100 with respect to the power source compartment 106). The driver's compartment 108 may include a housing 118 having a door 120. The housing 118 may be configured to fully enclose a driver or operator of the freight transport carrier 100 during operation of the freight transport carrier 100. The door 120 may provide selective access to the interior of the driver's compartment 108 to allow for the driver to enter and/or exit the driver's compartment 108. By fully enclosing the driver of the freight transport carrier 100 during operation, the freight transport carrier 100 provides significantly improved safety, as compared to traditional tug and dolly systems. For example, the driver's compartment 108 may include seat belts, airbags, and various other safety features that are not included in traditional tug and dolly systems. Additionally, by fully enclosing the driver of the freight transport carrier 100 during operation, the driver's compartment 108 may protect the driver from weather-related hazards (e.g., precipitation, extreme outdoor temperatures, lightning) or other occupational hazards present in the operating environment for these vehicles. Furthermore, the driver's compartment 108 may additionally include various temperature control systems (e.g., air conditioning, heating systems) to further protect the driver from extreme outdoor temperatures.

The driver's compartment 108 furthers includes traditional motor vehicle operating controls (e.g., a steering wheel, a gear shifting mechanism, a brake pedal, a gas pedal, a clutch operation mechanism) to allow the driver to control the freight transport carrier 100 during operation of the freight transport carrier 100.

The chassis 110 is coupled to and configured to support each of the power source compartment 106 and the driver's compartment 108. The chassis 110 may include at least a portion of a drivetrain system configured to transfer power supplied by the power source 115 of the power source compartment 106 into rotational motion of the plurality of wheels 112. The drivetrain of the freight transport carrier 100 may be configured as a two-wheel drive, a four-wheel drive, a six-wheel drive, an all-wheel drive, or any other suitable drivetrain configuration.

The plurality of wheels 112 are rotatably coupled to the chassis 110 (e.g., to an axle of the drivetrain). As illustrated in the exemplary embodiment of FIG. 1, the plurality of wheels 112 may include six wheels. It will be appreciated that, in some embodiments, there may be more or less than six wheels. For example, in some embodiments, there may be four, six, eight, ten, or any other number of wheels, as deemed necessary or desirable for a given application.

The slave tray loading unit 104 is coupled to and supported by the chassis 110 of the freight transport carrier 100. The slave tray loading unit 104 includes a front slave tray 122, a middle slave tray 124 adjacent the front slave tray 122, a slave tray actuation mechanism 126, an actuatable rear slave tray 128 adjacent the middle slave tray 124, and at least one slave tray locking mechanism 130. The front slave tray 122 is coupled to and supported by the chassis 110 and preferably is disposed immediately rearward of the driver's compartment 108.

As best illustrated in FIG. 2, the front slave tray 122 includes a support frame assembly 132 and a plurality of roller sub-assemblies 134 supported by the support frame assembly 132. The support frame assembly 132 includes at least one longitudinally-extending support member 136 which is coupled to a plurality of laterally-extending support members 138, and a retaining mechanism, such as a tie-down strap mechanism 140. The plurality of longitudinally-extending support members 136 and the plurality of laterally-extending support members 138 are rigidly coupled together in a cross-linked manner to form the support frame assembly 132. In the illustrated embodiment provided in FIG. 2, the support frame assembly 132 includes four longitudinally-extending support members 136 (e.g., two inner longitudinally-extending support members and two outer longitudinally-extending support members) and four laterally-extending support members 138 (e.g., two inner laterally-extending support members and two outer laterally-extending support members).

It should be appreciated that various other configurations of the support frame assembly 132 are possible. In some embodiments, the support frame assembly 132 may include more or less than four longitudinally-extending support members 136 and/or laterally-extending support members 138 (e.g., two, three, five, six, etc.), as desired for a given application. For example, if a higher load capacity is required for a given application, the number of longitudinally-extending support members 136 and/or laterally-extending support members 138 may be increased to provide the necessary additional capacity. Conversely, if a lower load capacity is required for a given application, the number of longitudinally-extending support members 136 and/or laterally-extending support members 138 may be decreased to allow for a reduction in material costs associated with the manufacturing of the support frame assembly 132.

The tie-down strap mechanism 140 is rigidly fixed to an outer longitudinally-extending support member 136. The tie-down strap mechanism 140 includes a tie-down strap configured to selectively tie down, restrain, or otherwise secure a load (e.g., freight, cargo, baggage, etc.) received on or supported by the front slave tray 122. Although the illustrated front slave tray 122 includes a single tie-down strap mechanism 140, in some embodiments, the front slave tray 122 may include additional tie-down strap mechanisms 140 to provide additional securement and/or restraint to the load received on or supported by the front slave tray 122. For example, in some instances, the front slave tray 122 may include between one or a plurality of tie-down strap mechanisms 140, as deemed necessary for a given application. In one embodiment, three tie-down strap mechanisms are integrated into the freight transport carrier 100.

The plurality of roller sub-assemblies 134 are each arranged and configured to rollably receive a load (e.g., freight, cargo, baggage, etc.) to be transported by the freight transport carrier 100. The plurality of roller sub-assemblies 134 each comprise a roller track 142 coupled to and supporting a plurality of rollers 144. The roller track 142 of each of the plurality of roller sub-assemblies 134 runs longitudinally along the front slave tray 122. The plurality of rollers 144 of each of the plurality of roller sub-assemblies 134 are arranged along the corresponding roller track 142.

The middle slave tray 124 is similarly coupled to and supported by the chassis 110. The middle slave tray 124 is immediately adjacent to and disposed rearward of the front slave tray 122 (i.e., closer to the rear end 117 of the freight transport carrier 100 with respect to the front slave tray 122). The middle slave tray 124 is further substantially similar in construction to the front slave tray 122. As such, it will be appreciated that the above description of the front slave tray 122 may similarly be applied to the middle slave tray 124. For example, the middle slave tray 124 similarly includes a support frame assembly 132 and a plurality of roller sub-assemblies 134.

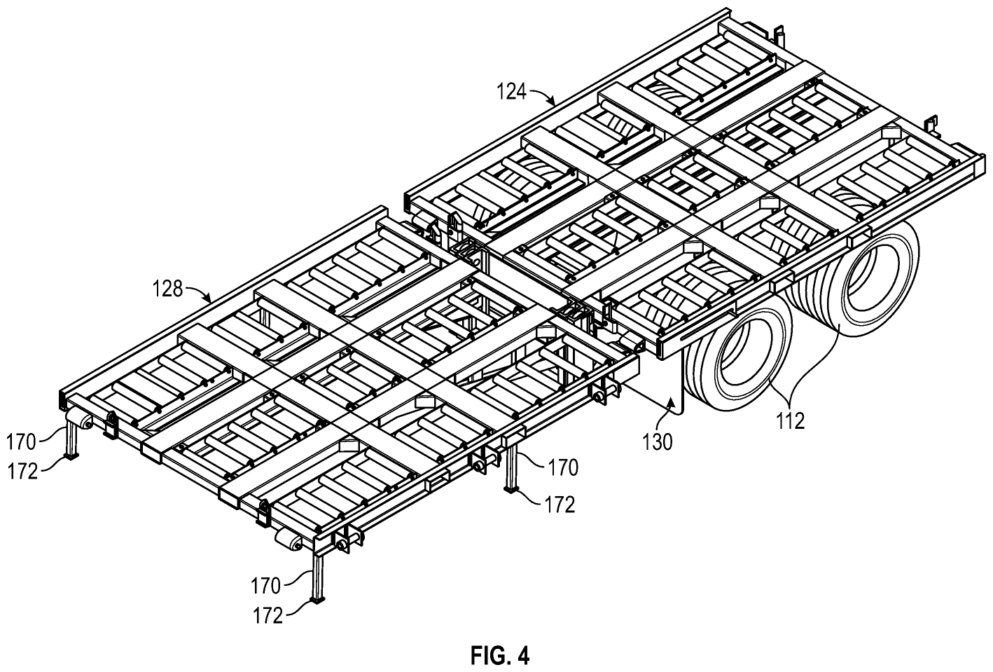

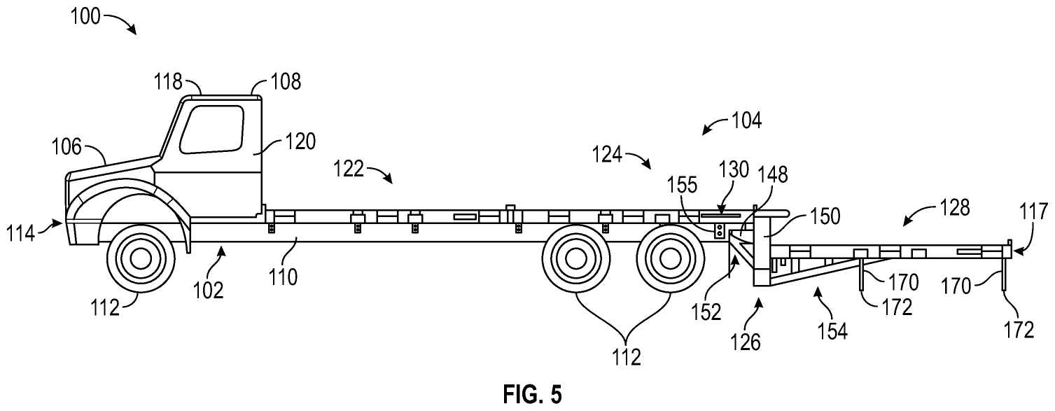

The slave tray actuation mechanism 126 is rigidly fixed and supported adjacent a rear end of the chassis 110 (i.e., an end of the chassis 110 closest to the rear end 117 of the freight transport carrier 100). The slave tray actuation mechanism 126 is further configured to support and selectively actuate the actuatable rear slave tray 128 between first or lowered position (shown in FIGS. 5-7) and a second or raised position (shown in FIGS. 1-4). As best illustrated in FIG. 1, the slave tray actuation mechanism 126 includes an actuation power source 148, a mast assembly 150, a mast support assembly 152, and a rear slave tray support assembly 154. In some instances, some or all of the components of the slave tray actuation mechanism 126 may include a specialized underbody coating configured to protect the various components from damage and prevent corrosion.

The actuation power source 148 is rigidly fixed to the chassis 110 at the rear end of the chassis 110. In some other embodiments, the actuation power source 148 may be arranged elsewhere on the chassis 110 or elsewhere on the freight transport carrier 100. In any case, the actuation power source 148 is configured to selectively actuate the mast assembly 150 for movement between a retracted position (e.g., when the actuatable rear slave tray 128 is in the raised position) and an extended position (e.g., when the actuatable rear slave tray 128 is in the lowered position) and any point intermediate these two positions. The actuation power source 148 may be any suitable power source for providing linear actuation to the mast assembly 150. For example, in some embodiments, the actuation power source 148 may be a motor (e.g., an electric motor). In some other embodiments, the actuation power source 148 may be a hydraulic pump in fluid communication with various actuation cylinders configured to selectively move the mast assembly 150 between the retracted position and the extended position. Furthermore, the actuation power source 148 is configured to effectively actuate the mast assembly 150 between the retracted position and the extended position (thereby effectively actuating the actuatable rear slave tray 128 between the raised position on the lowered position) while the actuatable rear slave tray 128 is carrying a load of up to 15,500 pounds.

The actuation power source 148 is in communication with a user interface 155 (shown in FIGS. 1 and 5) for controlling actuation of the mast assembly 150. For example, the user interface 155 may comprise various buttons for raising, lowering, and/or stopping movement of the actuatable rear slave tray 128. The user interface 155 is located on an exterior portion of the freight transport carrier 100 proximate the actuation power source 148. The user interface 155 being located on an exterior portion of the freight transport carrier 100 (as opposed to being located within the driver's compartment 108) prevents the user from accidentally attempting to actuate the actuatable rear slave tray 128 while the freight transport carrier 100 is being driven or is otherwise in a position or location not suitable for movement of the actuatable rear slave tray 128. Further, in some instances, the user interface 155 may be a tethered user interface 155 (e.g., a wired or wireless controller) that may be in communication with the actuation power source 148 to control actuation of the mast assembly 150. For example, the user interface 155 may be configured to control actuation of the mast assembly 150 within a distance of zero to twenty feet from the mast assembly 150. By allowing the mast assembly 150 to be controlled from a distance, a user of the freight transport carrier 100 may more safely actuate the mast assembly 150, as opposed to controlling the mast assembly 150 from a fixed location adjacent to the mast assembly 150.

The actuation power source 148 may further be in communication with the controller 116 of the power source 115. In some instances, the controller 116 may be configured to prevent movement (e.g., driving) of the freight transport carrier 100 while the actuatable rear slave tray 128 is in the lowered position. In some instances, the controller 116 may be further configured to prevent actuation of the slave tray actuation mechanism 126 while the freight transport carrier 100 is being driven.

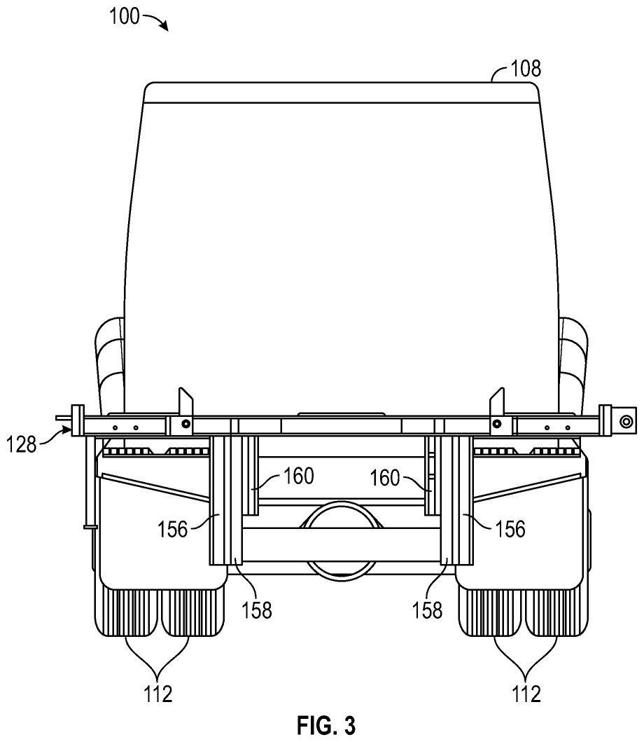

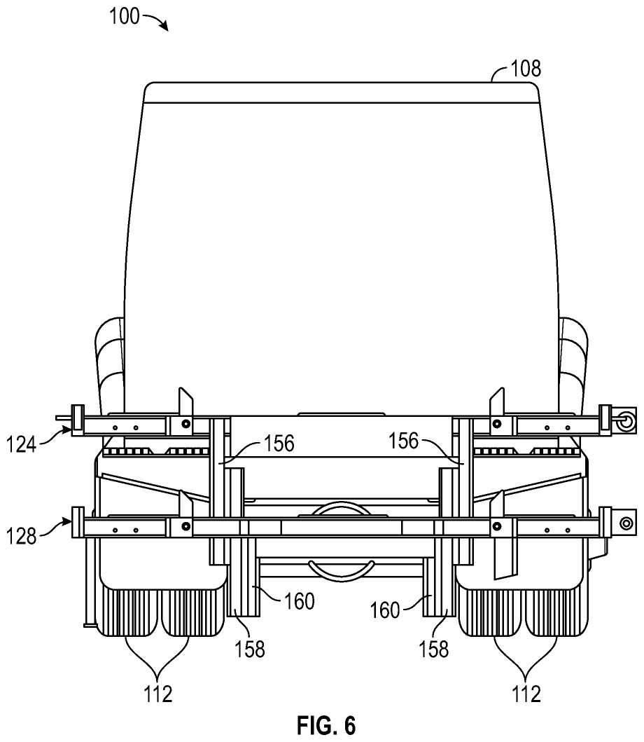

As best illustrated in FIGS. 3 and 6, the mast assembly 150 includes an outer mast sub-assembly 156, a middle mast sub-assembly 158, and an inner mast sub-assembly 160. The outer mast sub-assembly 156, the middle mast sub-assembly 158, and the inner mast sub-assembly 160 each define a pair of opposed U-shaped channels or tracks (e.g., masts) coupled together by a cross-member. The outer mast sub-assembly 156 is rigidly coupled to the rear end of the chassis 110. The outer mast sub-assembly 156 is further slidably coupled to the middle mast sub-assembly 158. The middle mast sub-assembly 158 may similarly be slidably coupled to the inner mast sub-assembly 160.

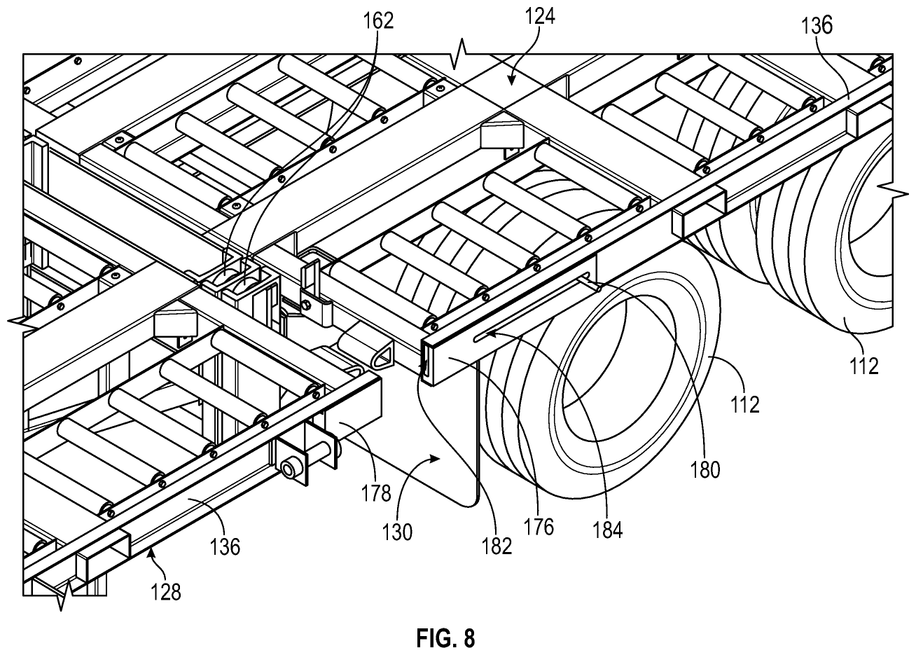

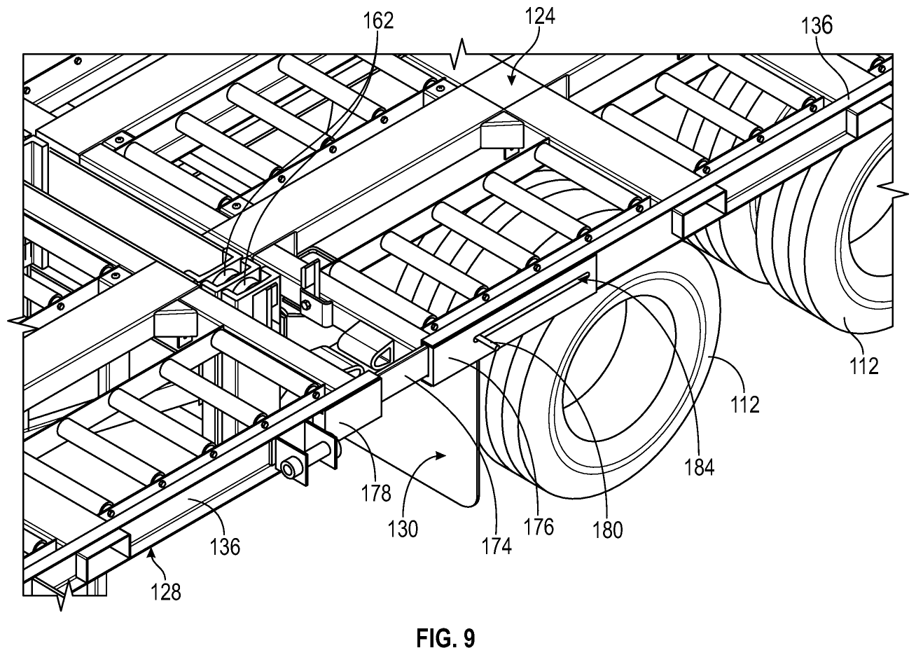

For example, the U-shaped channels or tracks defined by the outer mast sub-assembly 156 and the middle mast sub-assembly 158 are configured to receive roller wheels 162 (shown in FIGS. 8 and 9) that are rotatably coupled to the middle mast sub-assembly 158 and the inner mast sub-assembly 160, respectively. The roller wheels 162 are configured to roll within the corresponding U-shaped channels or tracks defined by the outer mast sub-assembly 156 and the middle mast sub-assembly 158 to allow the outer mast sub-assembly 156, the middle mast sub-assembly 158, and the inner mast sub-assembly 160 to slide vertically with respect to one another. As such, the outer mast sub-assembly 156, the middle mast sub-assembly 158, and the inner mast sub-assembly 160 are slidably coupled to each other. The inner mast sub-assembly 160 is rigidly coupled to the actuatable rear slave tray 128.

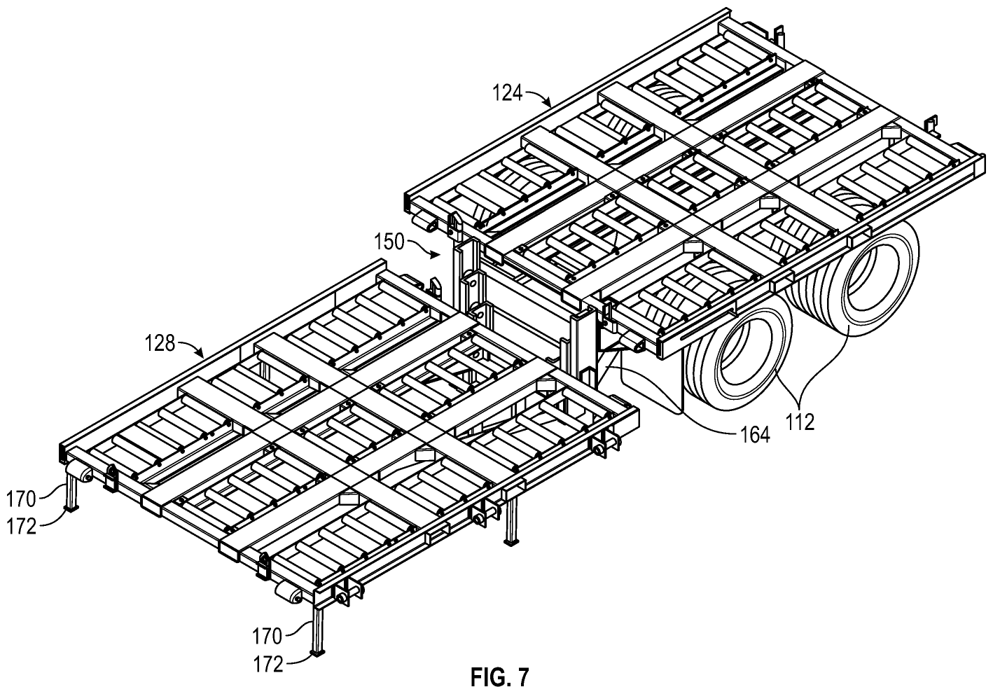

The mast support assembly 152 includes a pair of support members 164 (one of which being shown in FIG. 1 and the other being shown in FIG. 7). A first end of each of the pair of support members 164 is rigidly coupled to the chassis 110 proximate the rear end of the chassis 110. A second end of each of the pair of support members 164 is rigidly coupled to the outer mast sub-assembly 156 proximate a lower end of the outer mast sub-assembly 156. As such, the mast support assembly 152 is configured to provide additional support to the mast assembly 150.

The rear slave tray support assembly 154 includes a pair of primary support members 166. A first end of each primary support member 166 is rigidly coupled to the inner mast sub-assembly 160 proximate a lower end of the inner mast sub-assembly 160. A second end of each primary support member 166 is rigidly coupled to the actuatable rear slave tray 128 on a lower surface of the actuatable rear slave tray 128. Each of the primary support members 166 further includes a plurality of secondary support members 168. The plurality of secondary support members 168 are arranged along the length of the corresponding primary support member 166. A first end of each secondary support member 168 is rigidly coupled to the corresponding primary support member 166. A second end of each secondary support member 168 is rigidly coupled to the actuatable rear slave tray 128 on the lower surface of the actuatable rear slave tray 128. As such, the rear slave tray support assembly 154 is configured to provide additional support to the actuatable rear slave tray 128.

The actuatable rear slave tray 128 is coupled to the inner mast sub-assembly 160 of the mast assembly 150. The actuatable rear slave tray 128 is further coupled to and supported by the rear slave tray support assembly 154. The actuatable rear slave tray 128 is disposed rearward of the middle slave tray 124 (i.e., closer to the rear end 117 of the freight transport carrier 100 with respect to the middle slave tray 124). The actuatable rear slave tray 128 is further substantially similar in construction to the front slave tray 122. As such, it will be appreciated that the above description of the front slave tray 122 may similarly be applied to the actuatable rear slave tray 128. For example, the actuatable rear slave tray 128 similarly includes a support frame assembly 132 and a plurality of roller sub-assemblies 134. Further, as best shown in FIG. 2, the actuatable rear slave tray 128 similarly includes tie-down strap mechanisms 140. However, the actuatable rear slave tray 128 includes three tie-down strap mechanisms 140. As alluded to above, various embodiments of each of the slave trays 122, 124, 128 may include varying numbers of tie-down strap mechanisms 140 without departing from the scope of the present disclosure. That is, each of the front slave tray 122, the middle slave tray 124, and the actuatable rear slave tray 128 may include one, two, three, or any other suitable number of tie-down strap mechanisms 140.

The actuatable rear slave tray 128 further includes a plurality of support legs 170. The plurality of support legs 170 are configured to support the actuatable rear slave tray 128 when the actuatable rear slave tray 128 is in the lowered position. Specifically, each of the plurality of support legs 170 is coupled to and extends downwardly away from the lower surface of the actuatable rear slave tray 128, terminating at a corresponding support foot 172. When the actuatable rear slave tray 128 is in the lowered position, the plurality of support legs 170 are configured such that each of the support feet 172 are configured to contact the ground, thereby providing additional support to the actuatable rear slave tray 128.

According to one optional exemplary embodiment, the front slave tray 122, the middle slave tray 124, and the actuatable rear slave tray 128 may each include corresponding weight sensors configured to measure a load held by each corresponding slave tray. Each of the weight sensors may be in communication with the controller 116. In this optional exemplary embodiment, the controller 116 may be further configured to prevent movement of the freight transport carrier 100 when the weight of the load held by any of the front slave tray 122, the middle slave tray 124, and the actuatable rear slave tray 128 exceeds a slave tray weight threshold. For example, in some instances, the slave tray weight threshold may be fifteen thousand pounds. In some instances, the slave tray weight threshold may be between twelve thousand pounds and fifteen thousand pounds.

According to another optional exemplary embodiment, the controller 116 may be additionally or alternatively configured to prevent movement of the freight transport carrier 100 when an overall combined weight of the loads held by the front slave tray 122, the middle slave tray 124, and the actuatable rear slave tray 128 exceeds a vehicle weight threshold. For example, in some instances, the vehicle weight threshold may be forty-five thousand pounds. In some instances, the vehicle weight threshold may be between thirty thousand pounds and forty-five thousand pounds.

The front slave tray 122, the middle slave tray 124, and the actuatable rear slave tray 128 may each be low profile slave trays. Specifically, a thickness of each of the front slave tray 122, the middle slave tray 124, and the actuatable rear slave tray 128 (e.g., a distance from an upper surface to a lower surface of each slave tray) may be approximately five inches. In some instances the thickness may be between three inches and seven inches. In any case, the front slave tray 122, the middle slave tray 124, and the actuatable rear slave tray 128 are preferably, approximately the same thickness with respect to each other.

Additionally, the front slave tray 122, the middle slave tray 124, and the actuatable rear slave tray 128 may each be selectively replaceable. That is, in some instances, if any of the front slave tray 122, the middle slave tray 124, and the actuatable rear slave tray 128 are damaged, the damaged slave tray may be selectively replaced by a new slave tray of similar or identical construction.

Referring now to FIGS. 8-10, the slave tray locking mechanisms 130 (one of which being shown in FIGS. 8-10) are configured to provide additional locking mechanisms for retaining the actuatable rear slave tray 128 in the raised position. That is, the actuation power source 148 and the controller 116 may be configured to collectively retain the actuatable rear slave tray 128 in the raised position in the absence of a command to lower the actuatable rear slave tray 128, and the slave tray locking mechanisms 130 may act as secondary locking mechanisms. Each slave tray locking mechanism 130 includes a slidable locking member 174, a sliding chamber body 176, and a locking member receiving body 178.

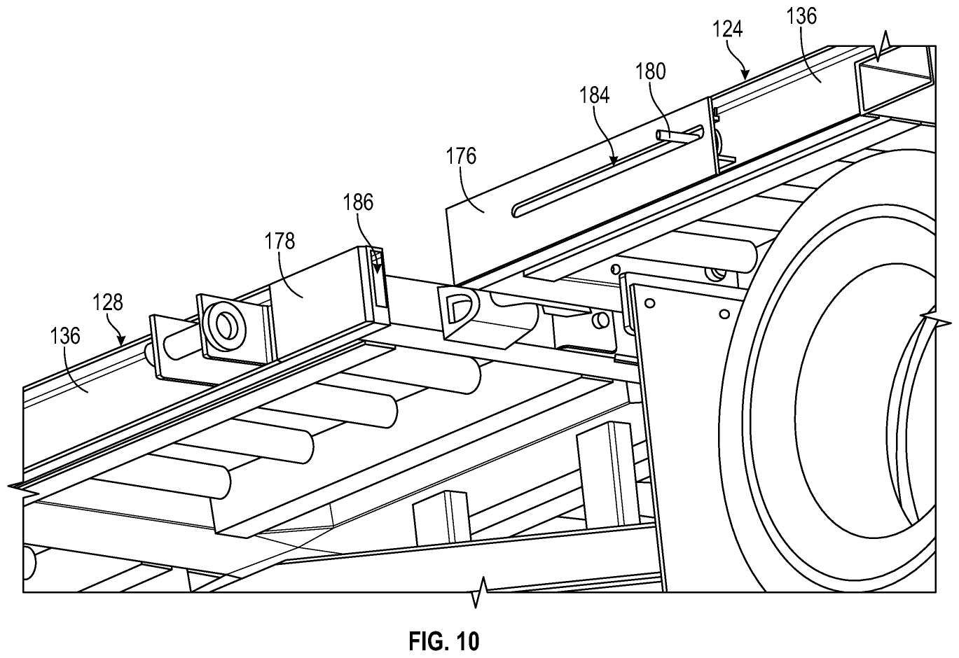

As best shown in FIG. 9, the slidable locking member 174 is disposed at least partially within the sliding chamber body 176. The slidable locking member 174 includes a control pin 180 configured to allow a user of the freight transport carrier 100 to selectively move the slidable locking member 174 between an opened position (shown in FIGS. 8 and 10) and a locked position (shown in FIG. 9).

The sliding chamber body 176 includes a sliding member channel 182 and a control pin slot 184. The sliding member channel 182 extends longitudinally (with respect to the freight transport carrier 100) through the sliding chamber body 176. The sliding member channel 182 is further configured to slidably receive the slidable locking member 174. The control pin slot 184 is configured to slidably receive the control pin 180 of the slidable locking member 174. The control pin slot 184 extends longitudinally (with respect to the freight transport carrier 100) through a portion of the sliding chamber body 176 to allow the control pin 180 (and thus the slidable locking member 174) to be moved between the open (or retracted) position and the locking (or extended) position.

In the exemplary embodiment shown in FIGS. 8-10, the sliding chamber body 176 is coupled to an outer longitudinally-extending support member 136 of the middle slave tray 124 proximate the rear end of the middle slave tray 124. In some other embodiments, the sliding chamber body 176 may be incorporated into the outer longitudinally-extending support member 136 of the middle slave tray 124, such that the sliding chamber body 176 and the corresponding longitudinally-extending support member 136 are integrally formed as a single, unitary body.

As best shown in FIG. 10, the locking member receiving body 178 includes a locking member receiving channel 186. The locking member receiving channel 186 extends longitudinally (with respect to the freight transport carrier 100) into the locking member receiving body 178. The locking member receiving channel 186 is further configured to receive the slidable locking member 174 when the slave tray locking mechanism 130 is in the locked position.

In the exemplary embodiment shown in FIGS. 8-10, the locking member receiving body 178 is coupled to an outer longitudinally-extending support member 136 of the actuatable rear slave tray 128 proximate the front end of the actuatable rear slave tray 128. In some other embodiments, the locking member receiving body 178 may be incorporated into the outer longitudinally-extending support member 136 of the actuatable rear slave tray 128, such that the locking member receiving body 178 and the outer longitudinally-extending support member 136 are integrally formed as a single, unitary body.

Now that the structure of the freight transport carrier 100 has been described above, an exemplary method of operation of the freight transport carrier 100 will be discussed below. It will be appreciated that the following method of operation is meant to be exemplary, and is in no way meant to be limiting. Various other methods of operation may be utilized, as desired, for various given applications.

During operation, a user (e.g., a driver) may drive the freight transport carrier 100 to a vehicle loading area to receive a load (e.g., cargo, freight, baggage). As discussed above, the controller 116 is configured to prevent movement of the freight transport carrier 100 when the actuatable rear slave tray 128 is in the lowered position. The controller 116 is further configured to prevent actuation of the slave tray actuation mechanism (and thus actuation of the actuatable rear slave tray 128) when the freight transport carrier 100 is being driven. As such, while the user drives the freight transport carrier 100 to the vehicle loading area, the actuatable rear slave tray 128 is always maintained in the raised position.

Once the user has driven the freight transport carrier 100 to the vehicle loading area, the user may then park the freight transport carrier 100 at the vehicle loading area. With the freight transport carrier 100 parked at the vehicle loading area, the user may then selectively lower the actuatable rear slave tray 128 from the raised position to the lowered position. To lower the actuatable rear slave tray 128, the user may first unlock the actuatable rear slave tray 128 by sliding each of the slidable locking members 174 of the slave tray locking mechanisms 130 from the locked position into the opened position using the corresponding control pin 180. Once the user has unlocked the actuatable rear slave tray 128, the user may then selectively lower the actuatable rear slave tray 128 using the user interface 155.

In some instances, when the actuatable rear slave tray 128 is in the lowered position, an upper surface of the actuatable rear slave tray 128 is configured to sit at approximately twenty-one inches above the ground. In some instances, when the actuatable rear slave tray 128 is in the lowered position, the upper surface of the actuatable rear slave tray 128 is configured to sit between fifteen inches and twenty-five inches above the ground.

With the actuatable rear slave tray 128 in the lowered position, the user may begin loading the actuatable rear slave tray 128. In some instances, the user may load the actuatable rear slave tray 128 from the rear end 117 of the freight transport carrier 100. For example, the user may place a first load on the roller sub-assembly 134 proximate the rear end 117. The user may then push the first load toward the front of the actuatable rear slave tray 128 (i.e., away from the rear end 117) to make space for a second load. The user may then place the second load on the roller sub-assembly 134. The user may then continue to add additional loads to the actuatable rear slave tray 128 until the actuatable rear slave tray 128 is fully loaded.

Once the actuatable rear slave tray 128 is fully loaded, the user may selectively raise the actuatable rear slave tray 128 from the lowered position to the raised position using the user interface 155. In some instances, when the actuatable rear slave tray 128 is in the raised position, the upper surface of the actuatable rear slave tray 128 is configured to sit at approximately thirty-six inches above the ground. In some instances, when the actuatable rear slave tray 128 is in the raised position, the upper surface of the actuatable rear slave tray 128 is configured to sit between thirty and forty inches above the ground.

In any case, when the actuatable rear slave tray 128 is in the raised position, the upper surface of the actuatable rear slave tray 128 is generally coplanar with the upper surfaces of each of the front slave tray 122 and the middle slave tray 124. As such, with the actuatable rear slave tray 128 in the raised position, the user may move the various loads held by the actuatable rear slave tray 128 forward, onto the middle slave tray 124 and subsequently onto the front slave tray 122, by rolling the various loads along the roller sub-assemblies 134 of each slave tray.

According to one optional, exemplary embodiment, the slidable locking members 174 may provide an additional, secondary support to the actuatable rear slave tray 128 while moving the various loads from the actuatable rear slave tray 128 to the middle slave tray 124 and the front slave tray 122. That is, in some optional configurations, the user may selectively lock the actuatable rear slave tray 128 in the raised position by sliding each of the slidable locking members 174 of the slave tray locking mechanisms 130 from the opened position into the locked position using the corresponding control pin 180 and, with the slidable locking members 174 in the locked position, at least a portion of the weight of the various loads on the actuatable rear slave tray 128, as well as the weight of the actuatable rear slave tray 128 itself, may be additionally and/or secondarily supported by the slave tray locking mechanisms 130.

Accordingly, in some optional configurations, a force required by the actuation power source 148 to maintain the actuatable rear slave tray 128 in the raised position may be temporarily reduced using the slidable locking members 174. In these optional configurations, by locking the actuatable rear slave tray 128 in the raised position while moving the various loads, wear associated with the actuation power source 148 holding or maintaining the actuatable rear slave tray 128 in the raised position may be reduced. It should be appreciated that this configuration is optional and, in some exemplary embodiments, the slidable locking members 174 are not configured to provide an additional, secondary support to the actuatable rear slave tray 128.

Once the loads from the actuatable rear slave tray 128 have been moved to the front slave tray 122 and/or the middle slave tray 124, the user may again lower the actuatable rear slave tray 128 to the lowered position, using the user interface 155, to place additional loads onto the actuatable rear slave tray 128. The user may repeat this process until each of the front slave tray 122, the middle slave tray 124, and the actuatable rear slave tray 128 are fully loaded (or the entire load to be transported has been loaded onto the freight transport carrier 100). In some instances, the weight of the various loads may be used to determine which of the front slave tray 122, the middle slave tray 124, or the actuatable rear slave tray 128 each of the various loads are placed onto.

In some instances, the fully-loaded freight transport carrier 100 has a maximum height (from the ground to the top of the load carried by the slave trays) of 114 inches. In some instances, the fully-loaded freight transport carrier 100 has a maximum height of 153.4 inches. In some instances, the fully-loaded freight transport carrier 100 has a maximum height between 100 and 160 inches.

After the user has loaded the freight transport carrier 100, the user may then raise the actuatable rear slave tray 128 to the raised position. With the actuatable rear slave tray 128 in the raised position, the user may then lock the actuatable rear slave tray 128 in the raised position by sliding the slidable locking member 174 from the opened position into the locked position using the control pin 180. With the slidable locking member 174 slid into the locked position, the actuatable rear slave tray 128 is mechanically prevented from lowering from the raised position to the lowered position. Thus, the slave tray locking mechanism 130 provides an additional safety feature for preventing accidental lowering of the actuatable rear slave tray 128 while the freight transport carrier 100 is being driven.

With the actuatable rear slave tray 128 in the raised position and the slave tray locking mechanism 130 in the locked position, the user may then enter the driver's compartment 108 and drive the freight transport carrier 100 to an unloading area to be unloaded. Once the user has driven the freight transport carrier 100 to the unloading area, the user may then park the freight transport carrier 100 in the unloading area and exit the driver's compartment 108.

The user may then unlock the actuatable rear slave tray 128 by sliding the slidable locking member 174 from the locked position to the opened position using the control pin 180. With the slidable locking member 174 slid into the opened position, the user may then lower the actuatable rear slave tray 128 and unload the freight transport carrier 100. Unloading the freight transport carrier 100 may be performed using a similar process to the process described above, with reference to loading the freight transport carrier 100. For example, the user may lower the actuatable rear slave tray 128 to the lowered position, unload the actuatable rear slave tray 128, raise the actuatable rear slave tray 128 to the raised position, pull various loads from the front slave tray 122 and/or middle slave tray 124 backward (i.e., toward the rear end 117 of the freight transport carrier 100) onto the actuatable rear slave tray 128, and repeat this process until the freight transport carrier 100 is completely unloaded.

Once the freight transport carrier 100 has been unloaded, the user may then raise the actuatable rear slave tray 128 to the raised position, slide the slidable locking member 174 into the locked position, and drive the freight transport carrier 100 to another loading area to be loaded again.

Accordingly, as described above, the freight transport carrier 100 is configured to allow a single user to safely load, transport, and unload various cargo, freight, and/or baggage. This may be particularly useful in transporting cargo, freight, and/or baggage between aircraft and terminals at an airport.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

What is claimed is:

1. A freight transport carrier comprising:
a tractor unit comprising a chassis, a plurality of wheels rotatably coupled to the chassis, and a power source coupled to the chassis and configured to selectively provide rotational motion to the plurality of wheels;
a slave tray loading unit coupled to the chassis of the tractor unit and comprising a plurality of slave trays, at least one of the plurality of slave trays being an actuatable slave tray selectively actuatable between a first position, in which the actuatable slave tray is configured to receive a load, and a second position, in which the actuatable slave tray is configured to transport the load; and
a slave tray actuation mechanism configured to selectively actuate the actuatable slave tray between the first position and the second position.

2. The freight transport carrier of claim 1, further comprising a controller communicably coupled to the power source and the slave tray actuation mechanism.

3. The freight transport carrier of claim 2, wherein the controller is configured to prevent actuation of the slave tray actuation mechanism while the freight transport carrier is in motion.

4. The freight transport carrier of claim 2, wherein the first position of the actuatable slave tray is a lowered position and the controller is configured to prevent movement of the freight transport carrier while the actuatable slave tray is in the lowered position.

5. The freight transport carrier of claim 1, wherein the slave tray actuation mechanism comprises a mast assembly coupled to a rear end of the chassis, a mast support assembly coupled to the chassis and configured to support the mast assembly, and an actuatable slave tray support assembly coupled to the mast assembly and configured to support the actuatable slave tray.

6. The freight transport carrier of claim 5, wherein the slave tray actuation mechanism further comprises an actuation power source configured to selectively actuate the mast assembly between a retracted position, in which the actuatable slave tray is in the second position, and an extended position, in which the actuatable slave tray is in the first position.

7. The freight transport carrier of claim 5, wherein the mast assembly comprises an outer mast sub-assembly and a middle mast sub-assembly slidably coupled to the outer mast sub-assembly.

8. The freight transport carrier of claim 7, wherein the mast assembly further comprises an inner mast sub-assembly slidably coupled to the middle mast sub-assembly and the actuatable slave tray is coupled to the inner mast sub-assembly.

9. The freight transport carrier of claim 1, further comprising a slave tray locking mechanism configured to selectively lock the actuatable slave tray in at least one of the first position or the second position.

10. The freight transport carrier of claim 9, wherein the slave tray locking mechanism comprises a sliding chamber body coupled to one of a non-actuatable slave tray of the plurality of slave trays or the actuatable slave tray, a locking member receiving body coupled to the other of the non-actuatable slave tray or the actuatable slave tray, and a locking member that is selectively movable between an opened position, in which the locking member is removed from the locking member receiving body, and a locked position, in which the locking member is received within the locking member receiving body and actuation of the actuatable slave tray is prevented.

11. A freight transport carrier comprising:
a tractor unit including a chassis, a plurality of wheels rotatably coupled to the chassis, and a power source coupled to the chassis and configured to selectively provide rotational motion to the plurality of wheels;
a slave tray loading unit coupled to the chassis of the tractor unit and including a plurality of slave trays, at least one of the plurality of slave trays being an actuatable slave tray that is selectively actuatable between a lowered position, in which the actuatable slave tray is configured to receive a load, and a raised position, in which the actuatable slave tray is configured to transport the load;
a slave tray actuation mechanism configured to selectively actuate the actuatable slave tray between the lowered position and the raised position; and
a controller communicably coupled to the power source and the slave tray actuation mechanism and configured to prevent actuation of the slave tray actuation mechanism while the freight transport carrier is in motion.

12. The freight transport carrier of claim 11, wherein the slave tray actuation mechanism comprises a mast assembly coupled to a rear end of the chassis, a mast support assembly coupled to the chassis and configured to support the mast assembly, and an actuatable slave tray support assembly coupled to the mast assembly and configured to support the actuatable slave tray.

13. The freight transport carrier of claim 12, wherein the slave tray actuation mechanism further comprises an actuation power source configured to selectively actuate the mast assembly between a retracted position, in which the actuatable slave tray is in the raised position, and an extended position, in which the actuatable slave tray is in the lowered position.

14. The freight transport carrier of claim 11, wherein the tractor unit further comprises an enclosed driver's compartment configured to enclose a driver of the freight transport carrier during operation.

15. The freight transport carrier of claim 14, further comprising a tethered user interface disposed outside of the enclosed driver's compartment and configured to allow a user to selectively actuate the actuatable slave tray between the lowered position and the raised position within a distance of zero to twenty feet from the slave tray actuation mechanism.

16. The freight transport carrier of claim 11, wherein each slave tray of the plurality of slave trays comprises at least one roller sub-assembly comprising a roller track running longitudinally along the corresponding slave tray and a plurality of rollers arranged along the roller track.

17. A freight transport carrier comprising:
a tractor unit including a chassis, a plurality of wheels rotatably coupled to the chassis, and a power source coupled to the chassis and configured to selectively provide rotational motion to the plurality of wheels;
a slave tray loading unit coupled to the chassis of the tractor unit and including a plurality of slave trays, at least one of the plurality of slave trays being an actuatable slave tray that is selectively actuatable between a first position, in which the actuatable slave tray is configured to receive a load, and a second position, in which the actuatable slave tray is configured to transport the load; and
a slave tray actuation mechanism configured to selectively actuate the actuatable slave tray between the first position and the second position and comprising a mast assembly coupled to a rear end of the chassis, a mast support assembly coupled to the chassis and configured to support the mast assembly, an actuatable slave tray support assembly coupled to the mast assembly and configured to support the actuatable slave tray, and an actuation power source configured to selectively actuate the mast assembly between a retracted position, in which the actuatable slave tray is in the second position, and an extended position, in which the actuatable slave tray is in the first position.

18. The freight transport carrier of claim 17, further comprising a controller communicably coupled to the power source and the slave tray actuation mechanism and configured to prevent actuation of the slave tray actuation mechanism while the freight transport carrier is in motion.

19. The freight transport carrier of claim 17, wherein, when the actuatable slave tray is in the first position, an upper surface of the actuatable slave tray is configured to sit between fifteen inches and twenty-five inches above the ground.

20. The freight transport carrier of claim 17, wherein, when the actuatable slave tray is in the second position, an upper surface of the actuatable slave tray is configured to sit between thirty and forty inches above the ground.
